(19) United States
(12) Patent Application Publication
(10) Pub. No.: US 2024/0427131 A1
(43) Pub. Date: Dec. 26, 2024

(54) MAGNIFYING OBSERVATION DEVICE

(71) Applicant: Keyence Corporation, Osaka (JP)

(72) Inventors: Hiroki TAKISE, Osaka (JP); Takashi FUTAMI, Osaka (JP); Ryosuke KONDO, Osaka (JP)

(73) Assignee: Keyence Corporation, Osaka (JP)

(21) Appl. No.: 18/591,017

(22) Filed: Feb. 29, 2024

(30) Foreign Application Priority Data
Jun. 26, 2023 (JP) 2023-103826

(51) Int. Cl. G02B 21/02; G02B 21/26; G02B 21/36

(52) U.S. Cl. CPC G02B 21/025; G02B 21/26; G02B 21/361; G02B 21/367; G02B 21/368

(57) ABSTRACT

Provided is a magnifying observation device capable of magnifying and observing a large object while having resistance to vibration. The magnifying observation device includes: a support column extending in a vertical direction; a movable stage including a rail and a holder; and an observation head. The rail is supported to be rotatable about a first rotation axis parallel to a horizontal direction such that the first rotation axis across the movable stage. The magnifying observation device further includes a block detachably attached to the horizontal upper surface of a placement table and locates a surface for an object to be observed closer to the observation head along the vertical direction. A position of the block is changeable in the horizontal direction by moving the placement table. An adjustable angular position includes an angular position such that a moving direction of the holder is orthogonal to the horizontal upper surface.

### CROSS-REFERENCE TO RELATED APPLICATIONS

The present application claims foreign priority based on Japanese Patent Application No. 2023-103826, filed Jun. 26, 2023, the contents of which are incorporated herein by reference.

### BACKGROUND OF THE INVENTION

### 1. Technical Field

The invention relates to a magnifying observation device.

### 2. Description of the Related Art

JP 2015-127780 A discloses a magnifying observation device (a microscope device 100). As illustrated in FIG. 3 of JP 2015-127780 A, the magnifying observation device described in JP 2015-127780 A includes an observation head (microscope head unit 4) that magnifies and observes an object (observation object S).

The observation head is supported by a support column (support base 40).

In the magnifying observation device described in JP 2015-127780 A, a first rotation axis (swinging axis 45) is provided on the support column at a height of the object in order to ensure the eccentricity.

Meanwhile, in the magnifying observation device described in JP 2015-127780 A, in a case where a large object is observed in a magnified manner, it is also necessary to increase sizes of a swinging section 46 and a head arm 49 which constitute the support column (support base 40).

If the swinging section 46 and the head arm 49 are increased in size, the center of gravity of a rotating (swinging) portion is inevitably separated greatly from the first rotation axis. Therefore, if the magnifying observation device described in JP 2015-127780 A is configured to magnify and observe a large object, resistance to vibration is likely to be lost.

### SUMMARY OF THE INVENTION

The invention has been made in view of the above problems, and aims to provide a magnifying observation device capable of generating an image for observing a large object in a magnified manner while having resistance to vibration.

According to one embodiment of the invention, a magnifying observation device magnifies and observes an object. The magnifying observation device includes a base, a placement table, a support column, a movable stage, an observation head, a block, and an image generation unit. The placement table is provided on the base and has a horizontal upper surface. The support column extends in a vertical direction from the base. The movable stage includes a rail and a holder. The rail is supported by the support column to be rotatable about a first rotation axis parallel to a first direction which is a direction along the horizontal upper surface. The holder is movable along the rail. The observation head includes a camera. The camera captures an image of the object through an objective lens to generate the image of the object. The observation head is held by the holder such that an optical axis of the camera is along a moving direction of the holder of the movable stage. The block is detachably attached to the horizontal upper surface of the placement table, and the object is placed on the block. The image generation unit generates an observation image based on the image from the camera of the observation head. The first rotation axis passes through the movable stage. A position of the block attached to the horizontal upper surface is changeable in a second direction which is a direction along the horizontal upper surface. The first direction and the second direction are orthogonal to each other. The rail of the movable stage is adjustable, with respect to the support column, to an angular position where the moving direction of the holder of the movable stage is orthogonal to the horizontal upper surface.

According to the magnifying observation device of the invention, it is possible to observe a large object in a magnified manner while having resistance to vibration.

### BRIEF DESCRIPTION OF THE DRAWINGS

FIG. 1 is a schematic view illustrating a front view of a magnifying observation device;

FIG. 2 is a perspective view of the magnifying observation device as viewed from the upper front side;

FIG. 3 is a perspective view of the magnifying observation device as viewed from the upper rear side;

FIG. 4 is a right side view of the magnifying observation device;

FIG. 5 is a front view of the magnifying observation device;

FIG. 6 is a perspective view of the magnifying observation device in which a block is detached from a placement table;

FIG. 7 is an enlarged perspective view of the magnifying observation device in which a rotating plate is detached from the block;

FIG. 8 is an enlarged perspective view of the magnifying observation device in which an object is detached from the rotating plate;

FIG. 9 is an enlarged perspective view of the magnifying observation device in which blocks are stacked in two stages;

FIG. 10 is an exploded perspective view of a support column;

FIG. 11 is an enlarged right side view of a lower portion of the magnifying observation device;

FIG. 12 is a bottom view illustrating a plurality of base legs provided in the magnifying observation device; and

FIG. 13 is a bottom view illustrating a modification of the plurality of base legs provided in the magnifying observation device.

### DETAILED DESCRIPTION

Hereinafter, embodiments of the invention will be described with reference to the drawings. Note that the same or corresponding portions are denoted by the same reference signs in the drawings, and the description thereof is not repeated. In addition, terms meaning positions or directions such as “upper” and “lower” are sometimes used in the following description. These terms are used for convenience to facilitate understanding of the embodiments, and are not limited to “upper”, “lower”, and the like in a vertical direction in a strict sense unless otherwise clearly specified.

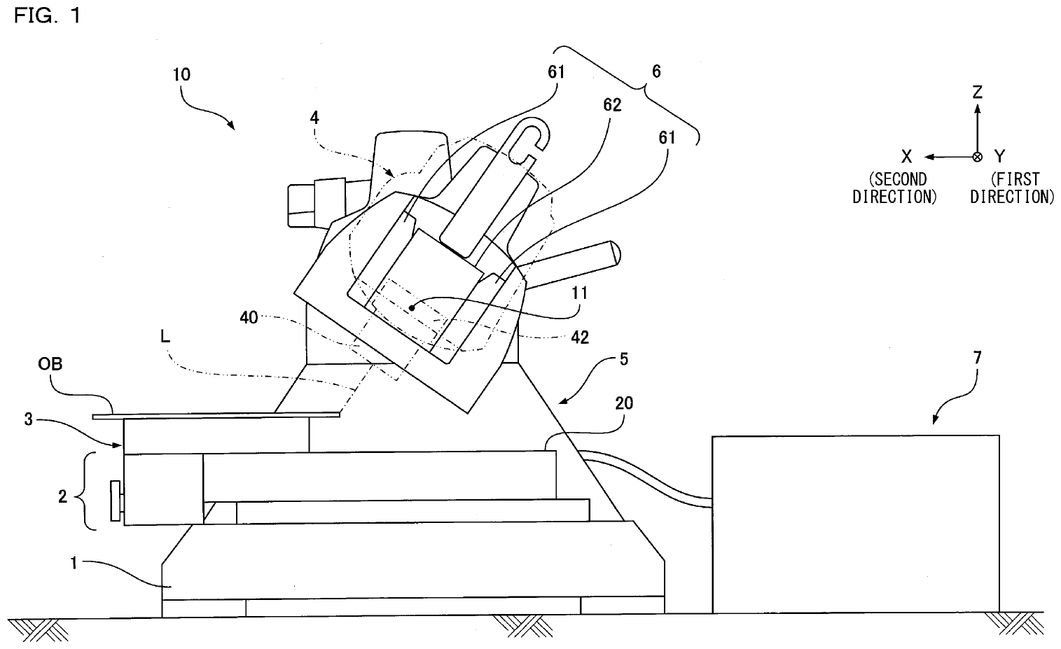

An outline of a magnifying observation device 10 according to an embodiment of the invention will be described with reference to FIG. 1. FIG. 1 is a schematic view illustrating a front view of the magnifying observation device 10.

As illustrated in FIG. 1, the magnifying observation device 10 provides an observation image for observing an object OB in a magnified manner. The magnifying observation device 10 includes a base 1, a placement table 2, a support column 5, a movable stage 6, an observation head 4, a block 3, and an image generation unit 7.

The placement table 2 is provided on the base 1 and has a horizontal upper surface 20. The support column 5 extends in the vertical direction from the base 1.

The movable stage 6 includes a rail 61 and a holder 62. The rail 61 is supported by the support column 5 to be rotatable about a first rotation axis 11 parallel to a first direction (Y direction) which is a direction along the horizontal upper surface 20. The holder 62 is movable along the rail 61.

The observation head 4 includes a camera 42. The camera 42 captures an image of the object OB via an objective lens 40 to generate the image of the object OB. The observation head 4 is held by the holder 62 such that an optical axis L of the camera 42 is along a moving direction of the holder 62 of the movable stage 6. The magnifying observation device 10 can adjust the focus of the camera 42 by moving the observation head 4 using the movable stage 6. In addition, the rail 61 is supported with respect to the support column 5 to be rotatable about the first rotation axis 11 parallel to the first direction (Y direction), which is the direction along the horizontal upper surface 20, and thus, the camera 42 also rotates about the first rotation axis 11 according to the rotation of the rail 61. As a result, the magnifying observation device 10 can provide the observation image in which the surface of the object OB including an end surface and a side surface of a trench and the like is magnified.

The block 3 is detachably attached to the horizontal upper surface 20 of the placement table 2, and the object OB is placed on the block 3. The image generation unit 7 generates the observation image based on the image from the camera 42 of the observation head 4. The first rotation axis 11 passes through the movable stage 6. A position of the block 3 attached to the horizontal upper surface 20 can be changed in a second direction (X direction) which is a direction along the horizontal upper surface 20.

The first direction (Y direction) and the second direction (X direction) are orthogonal to each other. The rail 61 of the movable stage 6 can be adjusted, with respect to the support column 5, to an angular position where the moving direction of the holder 62 of the movable stage 6 is orthogonal to the horizontal upper surface 20.

Since the first rotation axis 11 passes through the movable stage 6, a distance from the center of gravity of a portion rotating about the first rotation axis 11 to the first rotation axis 11 is short even when the magnifying observation device 10 is increased in size in order to tilt and observe the large object OB. Therefore, the magnifying observation device 10 has resistance to vibration even if the size thereof is increased in order to tilt and observe the large object OB. In addition, the magnifying observation device 10 loses the eccentricity since the first rotation axis 11 passes through the movable stage 6. However, the block 3 on which the object OB is placed brings the object OB close to the observation head 4 along the Z direction and is attached to the placement table 2 with the position being changed in the X direction. Therefore, since the observation head 4 rotates about the first rotation axis 11, that is, the observation head 4 is tilted, the magnifying observation device 10 can provide an image in which the object OB is magnified, tilted, and observed. As described above, the magnifying observation device 10 can generate the image in which the large object OB is magnified, tilted, and observed while having resistance to vibration.

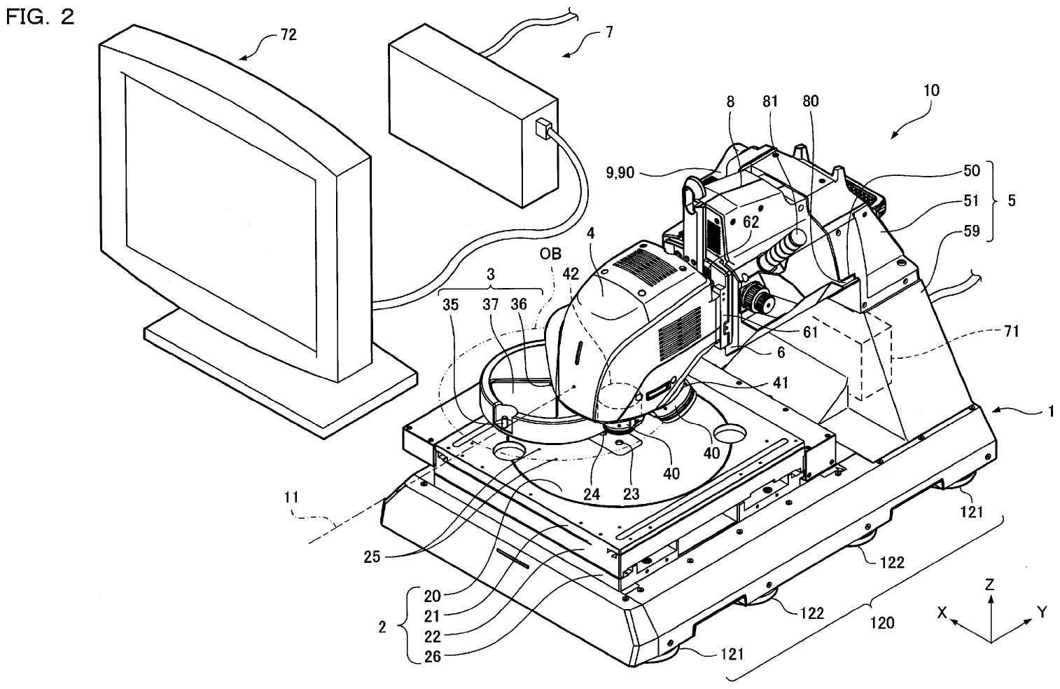

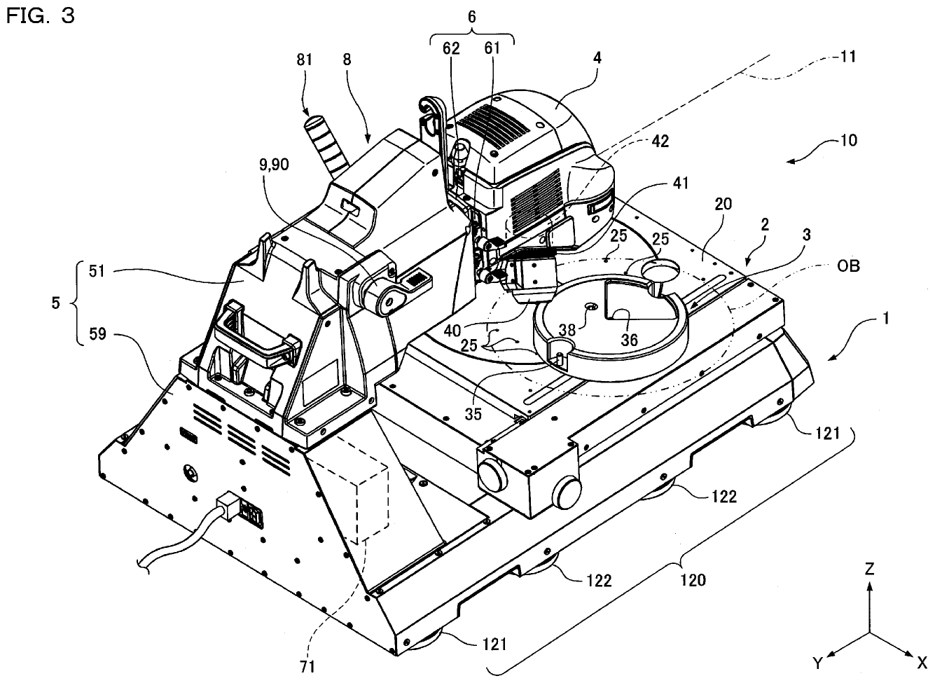

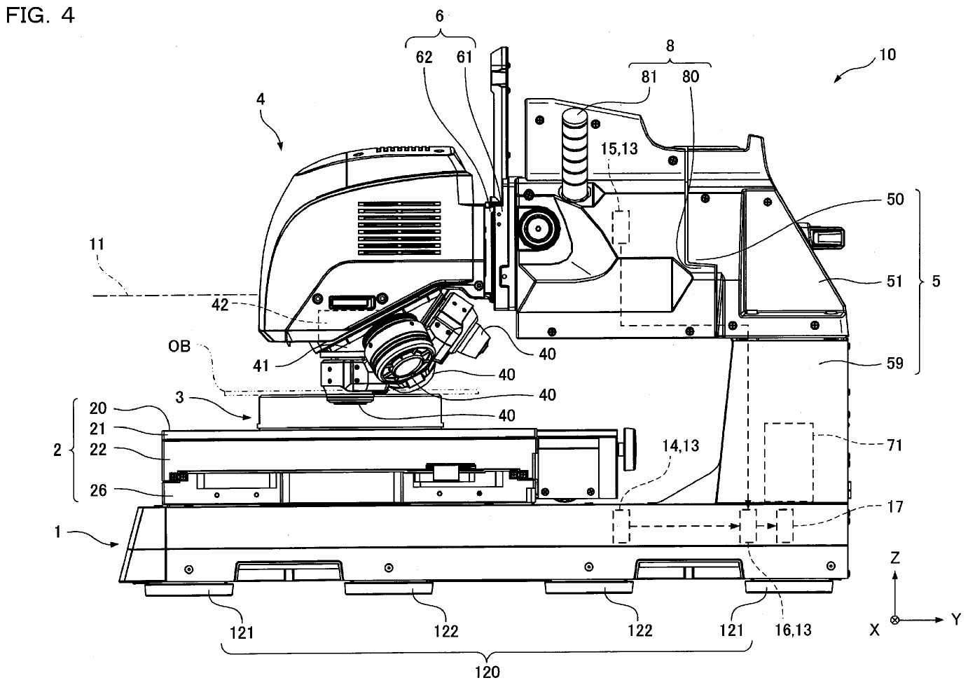

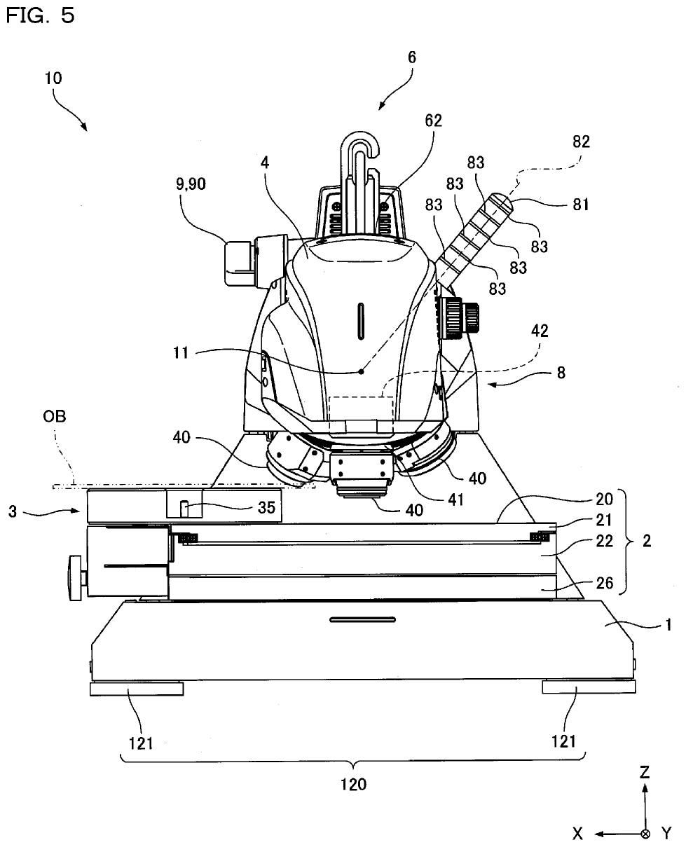

With reference to FIGS. 2 to 5, the magnifying observation device 10 according to an embodiment more appropriate to an actual machine of the invention will be described. FIG. 2 is a perspective view of the magnifying observation device 10 as viewed from the upper front side. FIG. 3 is a perspective view of the magnifying observation device 10 as viewed from the upper rear side. FIG. 4 is a right side view of the magnifying observation device 10. FIG. 5 is a front view of the magnifying observation device 10.

As illustrated in FIG. 2, the magnifying observation device 10 is a device that magnifies and observes the object OB. The magnifying observation device 10 includes the base 1, the placement table 2, the block 3, the observation head 4, the support column 5, the movable stage 6, and the image generation unit 7.

The placement table 2 is provided on the base 1 and has a horizontal upper surface 20. The block 3 can be attached to and detached from the horizontal upper surface 20 of the placement table 2, and the object OB is placed on the block 3. The observation head 4 magnifies and observes the object OB. The support column 5 is provided on the base 1 and supports the observation head 4. The movable stage 6 causes the observation head 4 to approach or separate from the horizontal upper surface 20 of the placement table 2 along the optical axis L of the camera 42 of the observation head 4. In a case where the rail 61 of the movable stage 6 is adjusted, with respect to the support column 5, to an angular position where a moving direction of the holder 62 of the movable stage 6 is orthogonal to the horizontal upper surface 20, the movable stage 6 causes the observation head 4 to approach or separate from the horizontal upper surface 20 of the placement table 2 along a Z direction. The Z direction is a direction from the horizontal upper surface 20 of the placement table 2 to the observation head 4. The image generation unit 7 generates an observation image of the object OB for magnified observation.

The observation head 4 is rotatable about the first rotation axis 11 parallel to a Y direction. The Y direction is a direction along the horizontal upper surface 20 of the placement table 2. The first rotation axis 11 passes through the movable stage 6. A position of the block 3 attached to the horizontal upper surface 20 of the placement table 2 can be changed in an X direction. The X direction is a direction along the horizontal upper surface 20 of the placement table 2. The X direction, the Y direction, and the Z direction are orthogonal to each other.

Since the first rotation axis 11 passes through the movable stage 6, a distance from the center of gravity of a portion rotating about the first rotation axis 11 to the first rotation axis 11 is short even when the magnifying observation device 10 is increased in size in order to observe the large object OB. Therefore, the magnifying observation device 10 has resistance to vibration even if the size thereof is increased in order to observe the large object OB. In addition, the magnifying observation device 10 loses the eccentricity since the first rotation axis 11 passes through the movable stage 6. However, the block 3 on which the object OB is placed brings the object OB close to the observation head 4 along the Z direction and is attached to the placement table 2 with the position being changed in the X direction. Therefore, since the observation head 4 rotates about the first rotation axis 11, that is, the observation head 4 is tilted, the magnifying observation device 10 can provide an image in which an end surface of the object OB having, for example, a disk shape is observed in a magnified manner. As described above, the magnifying observation device 10 can generate the observation image for observing the large object OB in a magnified manner while having resistance to vibration.

Hereinafter, the magnifying observation device 10 will be described in more detail with reference to FIGS. 2 to 5.

As illustrated in FIG. 2, the placement table 2 may move the horizontal upper surface 20, which allows the block 3 to be attached thereto, in the X direction and the Y direction with respect to the base 1. Such a placement table 2 is also referred to as an XY-direction stage. The placement table 2, which is the XY-direction stage, includes a lower pedestal portion 26, a middle X-direction stage 22, and an upper Y-direction stage 21. The pedestal portion 26 is fixed to the base 1. The X-direction stage 22 is placed on the pedestal portion 26 and is movable in the X direction with respect to the pedestal portion 26. The Y-direction stage 21 is placed on the X-direction stage 22 and is movable in the Y-direction with respect to the X-direction stage 22. The horizontal upper surface 20 of the Y-direction stage 21 can be attached to and detached from the block 3.

The magnifying observation device 10 may further include a display 72. The display 72 displays an image based on image data generated by the image generation unit 7. That is, the display 72 displays a magnified image of the object OB. The image generation unit 7 and the display 72 are not illustrated in FIG. 3 and subsequent drawings.

The magnifying observation device 10 further includes an information processing unit 71. The information processing unit 71 includes a control circuit, an electric circuit, and the like. The control circuit and the electric circuit control and drive the placement table 2, which is the XY-direction stage, and the movable stage 6.

As illustrated in FIGS. 2 to 5, the observation head 4 includes a plurality of (for example, four) objective lenses 40, a revolver 41, and an imaging device having the camera 42. The plurality of objective lenses 40 have different magnifications. The revolver 41 selects any one objective lens 40 among the plurality of objective lenses 40 by rotation. The selected objective lens 40 is used to magnify and observe the object OB.

The imaging device includes a non-telecentric lens (not illustrated), the camera 42 (imaging element), and a transmission unit (not illustrated). The objective lens 40 selected by the revolver 41 and the non-telecentric lens observe the object OB. The camera 42 (imaging element) captures an image of the object OB observed in a magnified manner, thereby creating image data (data of a raw image) of the object OB observed in a magnified manner. The transmission unit transmits the created image data to the image generation unit 7. The image generation unit 7 generates an observation image (image processed for observation) of the object OB observed in a magnified manner from the received data.

The magnifying observation device 10 may include a controller (not illustrated). The controller allows a user to operate the placement table 2, which is the XY-direction stage, the movable stage 6, and the revolver 41. Operations that can be performed by the controller are movement of the placement table 2, which is the XY-direction stage, and the movable stage 6, and rotation of the revolver 41.

The magnifying observation device 10 further includes a rotating holder 8. The rotating holder 8 is provided on the support column 5 to be rotatable about the first rotation axis 11. The rotating holder 8 holds the movable stage 6.

The rotating holder 8 eliminates the need for a rotating mechanism in each of the movable stage 6 and the observation head 4. Therefore, the magnifying observation device 10 can have a simple configuration.

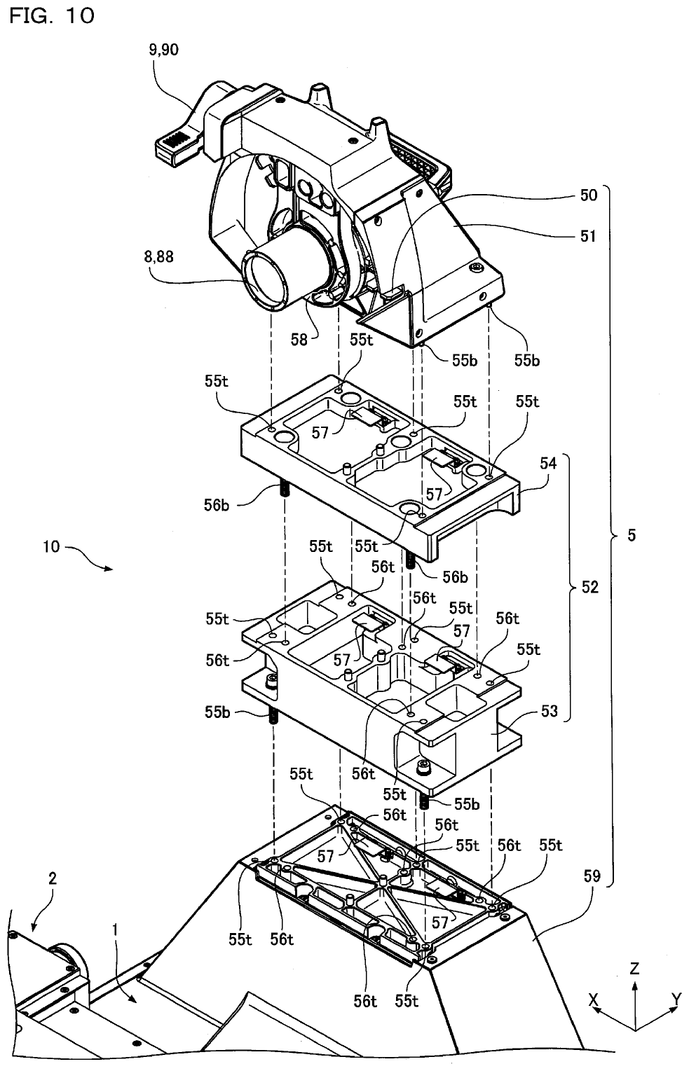

The rotating holder 8 is rotatably connected to the support column 5 at an end in the Y direction, and holds the movable stage 6 at an end in a direction opposite to the Y direction. The first rotation axis 11 also passes through the rotating holder 8 together with the movable stage 6. The rotating holder 8 has a shaft body 88 (see FIG. 10) which is a shaft. The shaft body 88 reaches the inside of the support column 5. The shaft body 88 constitutes the rotating mechanism.

The rotating holder 8 includes a Z-direction driving mechanism (not illustrated) therein. The Z-direction driving mechanism moves the observation head 4 in the Z direction by the movable stage 6.

As illustrated in FIGS. 2, 3, and 5, the magnifying observation device 10 further includes a lock mechanism 9. The lock mechanism 9 can fix the rotation of the rotating holder 8 with respect to the support column 5.

The rotating holder 8 is fixed to the support column 5 by the lock mechanism 9. Therefore, the observation head 4 held by the rotating holder 8 via the movable stage 6 is fixed at an angle appropriate for magnifying and observing the object OB. As a result, the magnifying observation device 10 can obtain an image in which the object OB is appropriately observed in a magnified manner.

As illustrated in FIG. 10, the lock mechanism 9 is provided on the support column 5. The lock mechanism 9 includes a lever 90, a lock shaft (not illustrated), and a brake bracket 58. The lever 90 is disposed outside the support column 5, and the lock shaft and the brake bracket 58 are disposed inside the support column 5. The lever 90 rotates in one direction to fix the rotating holder 8, and rotates in the other direction to release the fixation of the rotating holder 8. The lock shaft rotates together with the lever 90. The lock shaft rotates in one direction to decrease a diameter of the brake bracket 58. The lock shaft rotates in the other direction to increase the diameter of the brake bracket 58. When the diameter of the brake bracket 58 is decreased, the shaft body 88 of the rotating holder 8 is fixed. When the diameter of the brake bracket 58 is increased, the fixation of the shaft body 88 of the rotating holder 8 is released.

As illustrated in FIG. 4, the support column 5 includes a regulating member 50. The rotating holder 8 includes an abutting member 80. At the angular position where the moving direction of the holder 62 with respect to the rail 61 of the movable stage 6 is orthogonal to the horizontal upper surface 20, the abutting member 80 abuts on the regulating member 50.

The magnifying observation device 10 further includes a tilt angle measurement unit 13, a tilt angle display unit (not illustrated), and a display angle correction unit 17. The tilt angle measurement unit 13 measures a tilt angle which is an angle formed by the moving direction of the holder 62 with respect to the rail 61 of the movable stage 6 and a direction orthogonal to the horizontal upper surface 20. The tilt angle display unit displays the tilt angle. When the abutting member 80 abuts on the regulating member 50, the display angle correction unit 17 causes the tilt angle display unit to display that there is no tilt angle.

Since a state in which the abutting member 80 abuts on the regulating member 50 is defined as the tilt angle of 0°, the convenience of the user is improved. However, there is a case where the tilt angle measured by the tilt angle measurement unit 13 does not strictly indicate 0° due to an angular position deviation of the tilt angle measurement unit 13, the abutting member 80, and the regulating member 50. In this case, the display angle correction unit 17 causes the tilt angle display unit to display that there is no tilt angle (for example, 0°). Therefore, the tilt angle is displayed as 0° even in a case where the tilt angle measured by the tilt angle measurement unit 13 does not strictly indicate 0° (for example, within a range of ±1°) due to the angular position deviation or the like. As a result, the magnifying observation device 10 can improve the convenience of the user.

The tilt angle measurement unit 13 includes a base-side angle sensor 14, a rotating-side angle sensor 15, and a subtractor 16. The base-side angle sensor 14 is provided on the base 1. The base-side angle sensor 14 measures a base-side angle which is an angle formed by the vertical direction and the Z direction. The rotating-side angle sensor 15 is provided on the rotating holder 8. The rotating-side angle sensor 15 measures a rotating-side angle which is an angle formed by a direction observed by the observation head 4 and the vertical direction. The subtractor 16 subtracts the base-side angle from the rotating-side angle to calculate a tilt angle (an angle formed by the direction observed by the observation head 4 and the Z direction). The base-side angle sensor 14 and the rotating-side angle sensor 15 are acceleration sensors, for example.

In the display angle correction unit 17, an angle (for example, ±1°) considered to be an influence of the angular position deviation or the like is set in advance. When the tilt angle is within a range of the angle set in advance, for example, when the tilt angle is −1° or more and +1° or less, the display angle correction unit 17 causes the tilt angle display unit to display that there is no tilt angle (for example, 0°). The tilt angle display unit may be the display 72 illustrated in FIG. 2.

As illustrated in FIG. 5, the rotating holder 8 has a rod-like handle 81. A central axis 82 of the rod-like handle 81 is directed toward the first rotation axis 11 and is along a plane orthogonal to the first rotation axis 11.

The rod-like handle 81 allows the user to easily rotate the rotating holder 8. Therefore, the magnifying observation device 10 can improve the convenience of the user.

The rod-like handle 81 has a shape that is easily gripped, such as a cylindrical shape. The rod-like handle 81 has a plurality of anti-slip circumferential strips 83 along the direction of the central axis 82. The rod-like handle 81 protrudes between the Z direction and a direction opposite to the X direction from the rotating holder 8 (in the state illustrated in FIG. 5) having the tilt angle of 0°.

Therefore, the user pushes down the rod-like handle 81 to direct a direction observed by the observation head 4 toward the object OB placed on the block 3. As a result, the magnifying observation device 10 can further improve the convenience of the user.

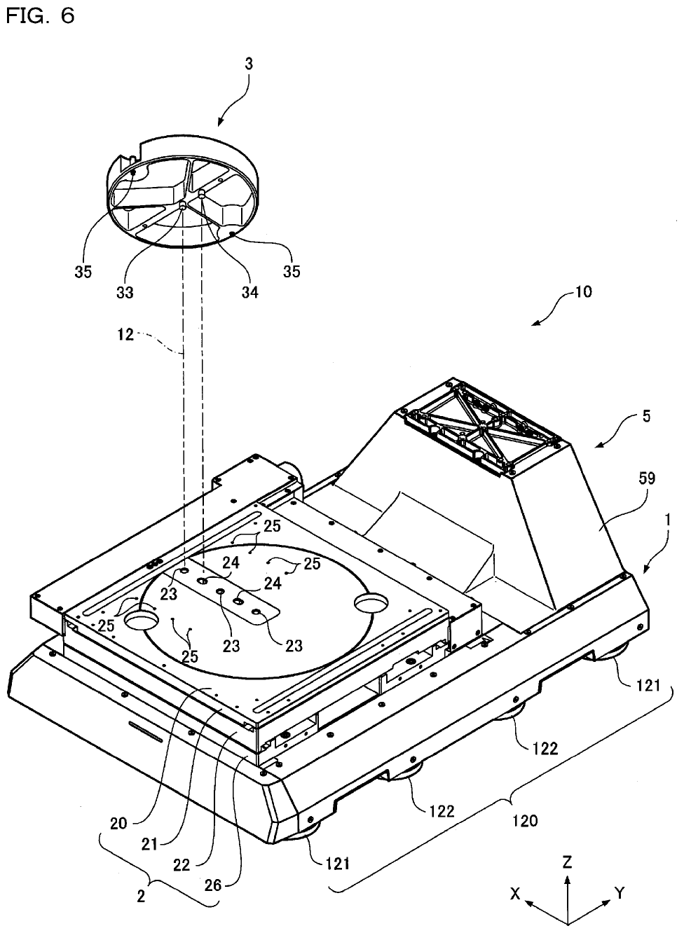

Hereinafter, the block 3 will be described in detail with reference to FIG. 6. FIG. 6 is a perspective view of the magnifying observation device 10 in which the block 3 is detached from the placement table 2.

As illustrated in FIG. 6, the horizontal upper surface 20 of the placement table 2 has a plurality of positioning holes 23 along the second direction (X direction). The block 3 has a positioning pin 33 that can be inserted into the positioning hole 23.

The position of the block 3 attached to the horizontal upper surface 20 of the placement table 2 can be easily changed in the X direction by the positioning holes 23 and the positioning pin 33. Therefore, the magnifying observation device 10 can improve the convenience of the user.

The positioning pin 33 is positioned at the center of the block 3 in a bottom view. Therefore, the block 3 is positioned by the positioning pin 33 at the center in the bottom view, and thus, is stabilized on the horizontal upper surface 20 of the placement table 2. As a result, the magnifying observation device 10 can appropriately magnify and observe the large object OB.

The horizontal upper surface 20 of the placement table 2 also has a plurality of detent holes 24 along the X direction. The block 3 also has a detent pin 34 insertable into the detent hole 24. A distance between the positioning pin 33 and the detent pin 34 is equal to a distance between the positioning hole 23 and the detent hole 24. Therefore, the block 3 is attached to the horizontal upper surface 20 of the placement table 2 by inserting the positioning pin 33 and the detent pin 34 into the positioning hole 23 and the detent hole 24. As a result, the block 3 does not rotate, and thus, is further stabilized on the horizontal upper surface 20 of the placement table 2. As a result, the magnifying observation device 10 can more appropriately magnify and observe the large object OB.

The detent hole 24 may have a diameter (that is, may be an elongated hole) with a margin in the X direction as compared with the positioning hole 23. An edge of the detent hole 24 may be chamfered in a mortar shape. As a result, the detent pin 34 is easily inserted into the detent hole 24 while performing a detent function. Therefore, the position of the block 3 attached to the horizontal upper surface 20 of the placement table 2 can be easily changed in the X direction. As a result, the magnifying observation device 10 can improve the convenience of the user.

The placement table 2 further includes fixing screw holes 25. The block 3 further includes fixing screws 35 that can be screwed into the fixing screw holes 25. The fixing screws 35 correspond to positions of the fixing screw holes 25 when the positioning pin 33 is inserted into the positioning hole 23.

The positioning pin 33 is inserted into the positioning hole 23 by aligning the positions of the fixing screws 35 with the fixing screw holes 25. Therefore, when being attached to the horizontal upper surface 20 of the placement table 2, the block 3 can be easily attached by aligning the positions of the fixing screws 35 with the fixing screw holes 25. Thus, the position of the block 3 attached to the horizontal upper surface 20 of the placement table 2 can be easily changed in the X direction. As a result, the magnifying observation device 10 can improve the convenience of the user.

In a case where the placement table 2 has the detent holes 24 and the block 3 has the detent pin 34, the positioning pin 33 and the detent pin 34 are inserted into the positioning hole 23 and the detent hole 24 by aligning the positions of the fixing screws 35 with the fixing screw holes 25. Therefore, the position of the block 3 attached to the horizontal upper surface 20 of the placement table 2 can be easily changed in the X direction. As a result, the magnifying observation device 10 can improve the convenience of the user.

In addition, rattling of the block 3 with respect to the placement table 2 is prevented since the fixing screws 35 are screwed into the fixing screw holes 25. Therefore, the block 3 is reliably fixed on the horizontal upper surface 20 of the placement table 2, and thus, is further stabilized. As a result, the magnifying observation device 10 can more appropriately magnify and observe the large object OB.

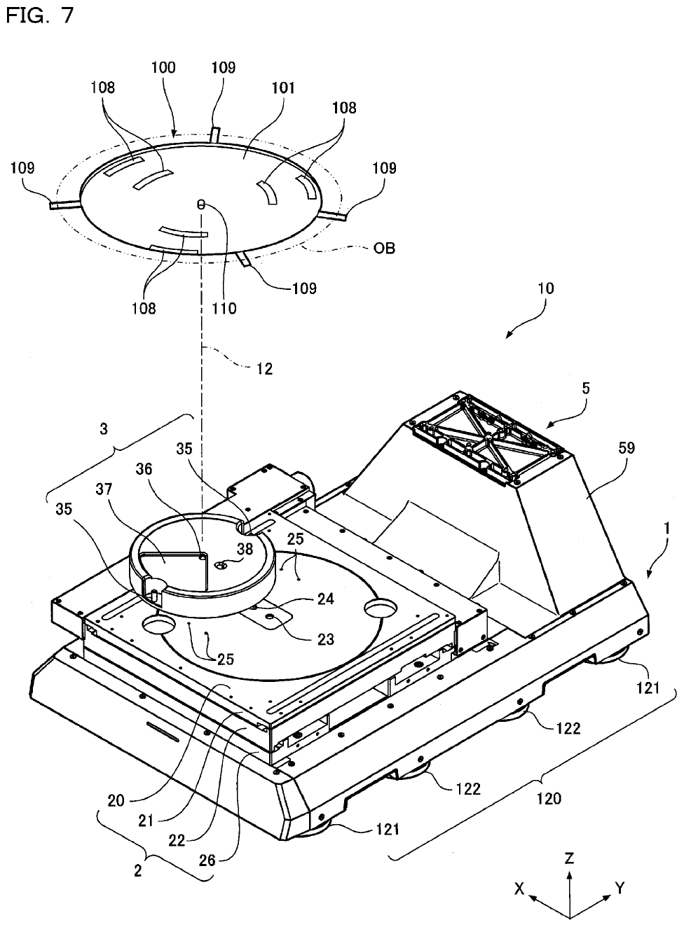

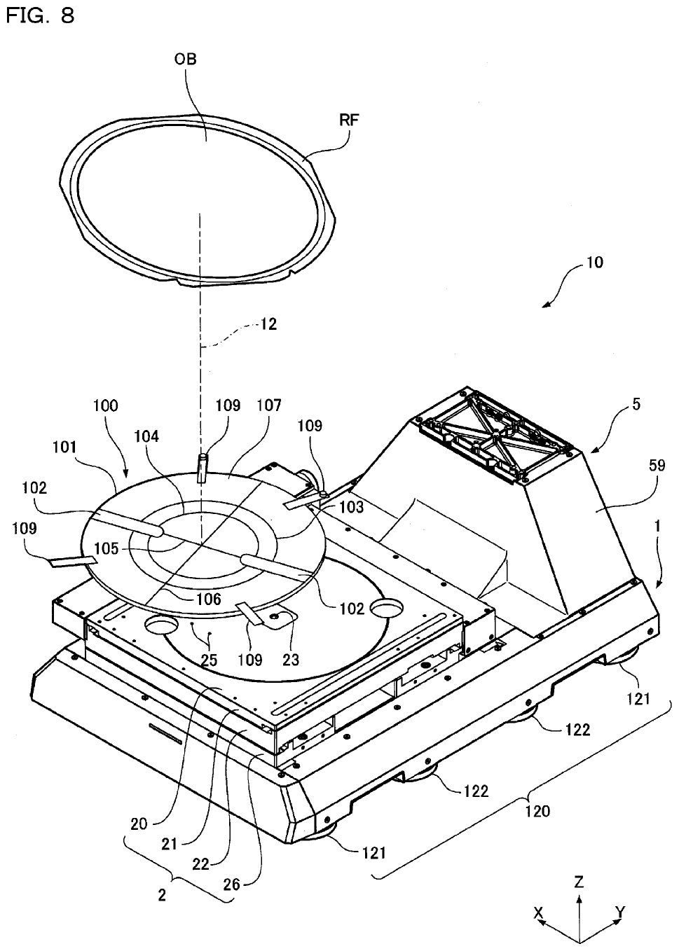

Hereinafter, a rotating plate 100 placed on the block 3 will be described in detail with reference to FIGS. 7 and 8. FIG. 7 is an enlarged perspective view of the magnifying observation device 10 in which the rotating plate 100 is detached from the block 3. FIG. 8 is an enlarged perspective view of the magnifying observation device 10 in which the object OB is detached from the rotating plate 100.

As illustrated in FIGS. 7 and 8, the magnifying observation device 10 further includes the rotating plate 100. The rotating plate 100 is mounted on the block 3 to be rotatable about a second rotation axis 12 orthogonal to the horizontal upper surface 20. The object OB is placed on the rotating plate 100.

The object OB is easily rotatable about the second rotation axis 12 together with the rotating plate 100. Therefore, a portion of the object OB observed in a magnified manner can be easily changed by rotation. As a result, the magnifying observation device 10 can improve the convenience of the user.

The rotating plate 100 includes a metal disk 101, resin protective members 108, and radial pins 109 disposed radially.

As illustrated in FIG. 8, the metal disk 101 has trenches 102 to 106 on a surface (upper surface 107) on which the object OB is placed. For example, when there is a water droplet in the object OB, the trenches 102 to 106 guide the water droplet. The trenches 102 to 106 further reduce a contact area between the metal disk 101 and the object OB, thereby preventing adhesion between the metal disk 101 and the object OB. The trenches 102 to 106 include a pair of finger insertion trenches 102, dual circular trenches 103 and 104, a lateral trench 105, and a longitudinal trench 106. The pair of finger insertion trenches 102 faces each other and is formed from an outer edge of the metal disk 101 toward the center (second rotation axis 12). The finger insertion trenches 102 are portions into which fingers of the user are inserted when the user detaches the object OB from the rotating plate 100. The dual circular trenches 103 and 104 include a large-diameter circular trench 103 and a small-diameter circular trench 104. The dual circular trenches 103 and 104 communicate with the pair of finger insertion trenches 102. The lateral trench 105 connects the pair of finger insertion trenches 102. The longitudinal trench 106 vertically crosses the lateral trench 105 at the center of the metal disk 101 and reaches the outer edge of the metal disk 101.

As illustrated in FIG. 7, the resin protective member 108 is attached to a lower surface of the metal disk 101. The resin protective member 108 prevents the metal disk 101 from directly touching the block 3. If the metal disk 101 rotates while directly touching the block 3, a problem such as generation of powder occurs due to sliding between the metal disk 101 and the block 3. However, the resin protective member 108 prevents the metal disk 101 from directly touching the block 3, and thus, the problem such as generation of powder is prevented. The resin protective member 108 is disposed to be rotationally symmetric with respect to the center of the metal disk 101 since the metal disk 101 is not tilted with respect to the block 3.

The number of the radial pins 109 is, for example, four. Each of the radial pins 109 is directed toward the center of the metal disk 101 and protrudes from the outer edge of the metal disk 101. The radial pins 109 are portions to be gripped when the metal disk 101 is rotated. The radial pins 109 are also used for positioning the object OB with respect to the rotating plate 100.

As illustrated in FIG. 8, the rotating plate 100 includes a reflector 107 that reflects light to the observation head 4 on at least the surface (upper surface 107) on which the object OB is placed.

When the observation head 4 magnifies and observes the object OB, light enters the observation head 4 by the reflector 107 functioning as a reflection plate. In particular, when the observation head 4 tilts and observes the object OB, the reflector 107 strongly exhibits a function as the reflection plate with respect to an end portion of the object OB. Therefore, the observation head 4 clearly magnifies and observes the object OB. As a result, the magnifying observation device 10 can appropriately magnify and observe the large object OB.

The reflector 107 is not particularly limited as long as it is a portion that reflects light to the observation head 4. The reflector 107 is preferably a white portion, and more preferably white alumite. White alumite is more likely to reflect light than members of other colors. In addition, the reflector 107 may be, for example, a diffuse illumination.

The placement table 2 has, on the horizontal upper surface 20, a reflection suppressing portion that hardly reflects light to the observation head 4. The reflection suppressing portion is not particularly limited as long as it is a portion that hardly reflects light to the observation head 4. The reflection suppressing portion is preferably a black portion, and more preferably black alumite. Black alumite is less likely to reflect light than members of other colors. The reflection suppressing portion is more preferably one of black alumite subjected to satin treatment, matt coating, and/or matting treatment.

The white alumite as the reflector 107 and the black alumite as the reflection suppressing portion make the contrast between the object OB and the other objects clear. Therefore, since the magnifying observation device 10 more clearly magnifies and observes the object OB, it is possible to more appropriately observe the large object OB in a magnified manner.

The object OB is, for example, a semiconductor wafer. The semiconductor wafer as the object OB has a diameter of 150 mm, 200 mm, 300 mm, or the like. The semiconductor wafer as the object OB is protected by a ring frame RF (also referred to as a tape frame). In the ring frame RF, a positioning trench is defined by a standard. The ring frame RF is placed on the rotating plate 100 together with the object OB being protected such that the positioning trench is located on the radial pins 109 or the rotating plate 100.

As illustrated in FIG. 7, the block 3 has a rotation axis hole 36 at the position of the second rotation axis 12. The rotating plate 100 further includes a rotation axis pin 110 that can be inserted into the rotation axis hole 36.

The rotation axis hole 36 and the rotation axis pin 110 facilitate attachment and detachment of the rotating plate 100 to and from the block 3. Therefore, the magnifying observation device 10 can improve the convenience of the user.

The rotation axis pin 110 is located at the center of the rotating plate 100 in the bottom view. Therefore, the rotating plate 100 rotates about the rotation axis pin 110 at the center in the bottom view. As a result, the portion of the object OB observed in a magnified manner can be more easily changed by rotation. As a result, the magnifying observation device 10 can further improve the convenience of the user.

The block 3 further includes a guide portion 37 that guides the rotation axis pin 110 of the rotating plate 100 to the rotation axis hole 36.

The rotation axis pin 110 is inserted into the rotation axis hole 36 by being guided by the guide portion 37. Therefore, even in a case where it is difficult to visually recognize the rotation axis hole 36 such as in a case where the rotating plate 100 is larger than the block 3, the rotation axis pin 110 can be easily inserted into the rotation axis hole 36 by the guide portion 37. As a result, the magnifying observation device 10 can improve the convenience of the user.

The guide portion 37 is a fan-shaped recess expanding with a position of the rotation axis hole 36 as the center. Since the guide portion 37 has the fan shape, the rotation axis pin 110 is moved to the center after abutting on any side of the fan shape, whereby the rotation axis pin 110 is more easily inserted into the rotation axis hole 36. Therefore, as a result, the magnifying observation device 10 can further improve the convenience of the user.

The rotation axis pin 110 of the rotating plate 100 can also be inserted into the positioning hole 23 of the placement table 2.

Since the rotation axis pin 110 can be inserted into the positioning hole 23, the rotating plate 100 can be directly attached to and detached from the horizontal upper surface 20 of the placement table 2. Therefore, since the block 3 is unnecessary, the magnifying observation device 10 can have a simple configuration. A case where the block 3 is unnecessary is a case where it is unnecessary to observe the object OB with the observation head 4 being tilted.

If the rotation axis pin 110 can be inserted into the positioning hole 23, the rotating plate 100 functions as the block 3.

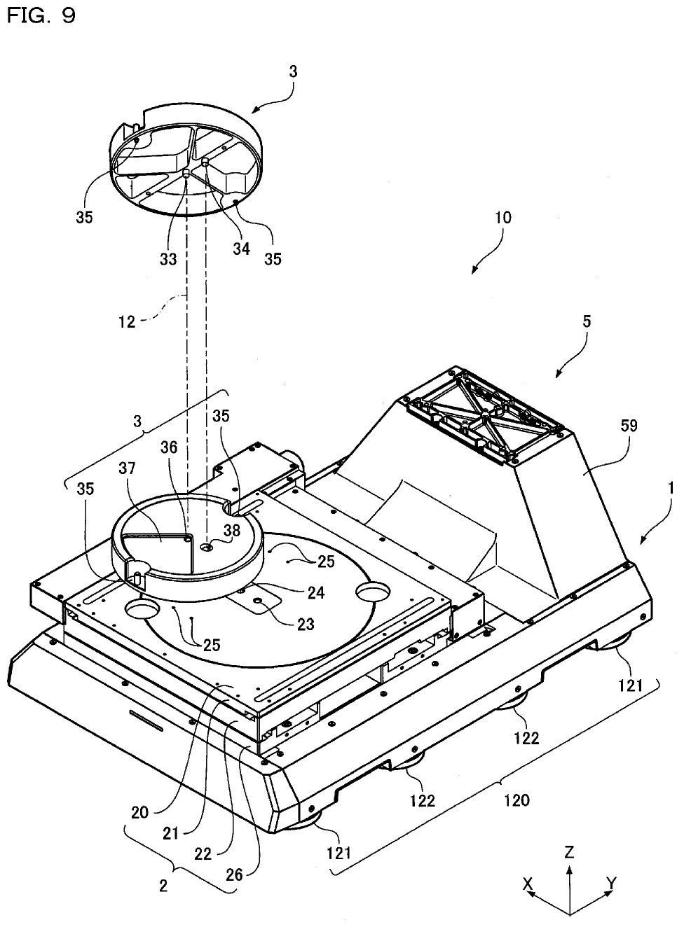

Hereinafter, a case where a plurality of the blocks 3 are stacked will be described with reference to FIG. 9. FIG. 9 is an enlarged perspective view of the magnifying observation device 10 in which the blocks 3 are disposed in two stages.

As illustrated in FIG. 9, the plurality of blocks 3 are stacked. Among the plurality of blocks 3, the positioning pin 33 of the upper block 3 is inserted into the rotation axis hole 36 of the lower block 3.

Since the plurality of blocks 3 are stacked, the position of the object OB can be flexibly changed in the Z direction. Therefore, the magnifying observation device 10 can improve the convenience of the user.

In a case where the upper block 3 also has the detent pin 34, the lower block 3 also has a block detent hole 38 into which the detent pin 34 of the upper block 3 is inserted. Similarly to the detent hole 24, the block detent hole 38 may also have a diameter (that is, may be an elongated hole) with a margin in the X direction as compared with the rotation axis hole 36. An edge of the block detent hole 38 may also be chamfered in a mortar shape.

Although FIG. 9 illustrates the upper block 3 and the lower block 3, that is, the blocks 3 stacked in two stages, the blocks 3 may be stacked in three or more stages.

Hereinafter, the support column 5 will be described in detail with reference to FIG. 10. FIG. 10 is an exploded perspective view of the support column 5.

As illustrated in FIG. 10, the support column 5 includes an upper support column 51 and a lower support column 59. The upper support column 51 is a portion having the regulating member 50 and the brake bracket 58. The lower support column 59 is a portion provided on the base 1.

The support column 5 may have a spacer 52 between the upper support column 51 and the lower support column 59. The spacer 52 includes a thick spacer 53 and a thin spacer 54. The thick spacer 53 has a thickness (length in the up-down direction) of 40 mm to 80 mm (for example, 60 mm). The thin spacer 54 is thinner than the thick spacer 53. The thin spacer 54 has, for example, a half thickness (length in the up-down direction) of the thick spacer 53.

The lower support column 59 has a group of outer screw holes 55t, a group of inner screw holes 56t, and a pair of engaging tools 57 on an upper end surface.

The thick spacer 53 has a group of outer screws 55b and an engaging tool storage space (not illustrated) on a lower surface. The group of outer screws 55b is screwed with the group of outer screw holes 55t on the lower side. The engaging tool storage space stores the pair of engaging tools 57 on the lower side. An upper surface of the thick spacer 53 has the same configuration as the upper end surface of the lower support column 59, and includes the group of outer screw holes 55t, the group of inner screw holes 56t, and the pair of engaging tools 57.

The thin spacer 54 has the group of inner screws 56b and the engaging tool storage space (not illustrated) on a lower surface. The group of inner screws 56b is screwed with the group of inner screw holes 56t on the lower side. The thin spacer 54 has the group of outer screw holes 55t and the pair of engaging tools 57 on an upper surface.

The upper support column 51 has the group of outer screws 55b and a pair of engaged tools (not illustrated) on a lower surface. The pair of engaged tools is engaged with the pair of engaging tools 57 on the lower side.

The spacers 52 can be freely overlapped except that the thin spacers 54 cannot be overlapped with each other between the upper support column 51 and the lower support column 59. Specifically, between the upper support column 51 and the lower support column 59, the thick spacers 53 can be overlapped, the thick spacer 53 can be overlapped on the thin spacer 54, and the thin spacer 54 can be overlapped on the thick spacer 53. In addition, the number of the thick spacers 53 and the number of the thin spacers 54 are not particularly limited.

Therefore, the spacer 52 allows the position of the upper support column 51 to be changed in the Z direction. Since the rotating holder 8 is connected to the upper support column 51 and the rotating holder 8 holds the observation head 4, the position of the observation head 4 can be changed in the Z direction by the spacer 52. As a result, the magnifying observation device 10 can improve the convenience of the user.

In addition, since the pair of engaged tools of the upper support column 51 is engaged with the pair of engaging tools 57 on the lower side, the upper support column 51 stands by itself even before screwing when being attached to the spacer 52 or the lower support column 59. Therefore, the support column 5 is prevented from falling down when the position in the Z direction is changed. As a result, the magnifying observation device 10 can improve the stability.

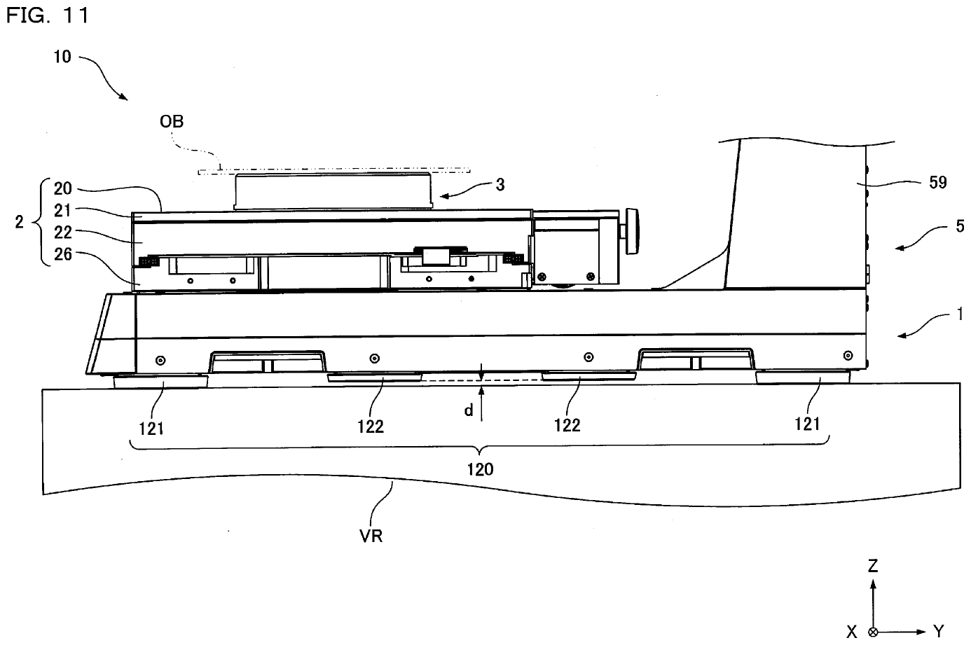

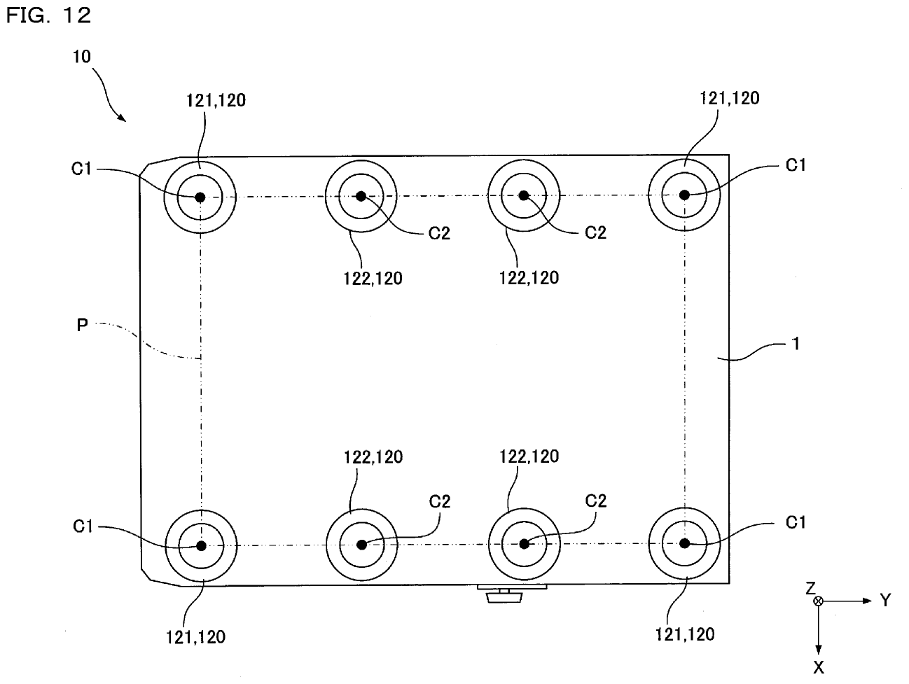

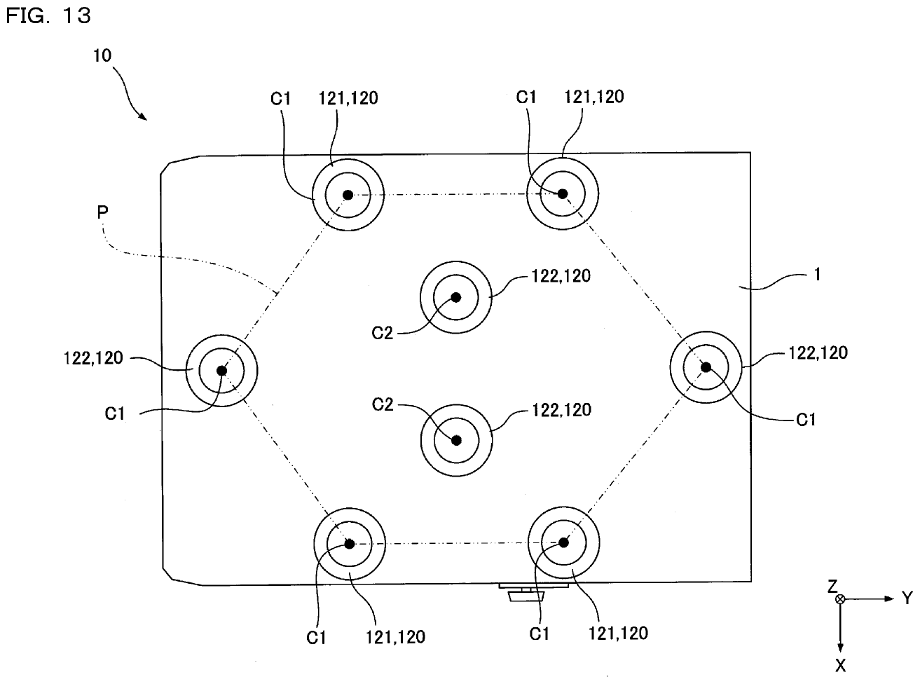

Hereinafter, a plurality of base legs 120 provided in the magnifying observation device 10 will be described with reference to FIGS. 11 to 13. FIG. 11 is an enlarged right side view of a lower portion of the magnifying observation device 10. FIG. 12 is a bottom view illustrating the plurality of base legs 120 provided in the magnifying observation device 10. FIG. 13 is a bottom view illustrating a modification of the plurality of base legs 120 provided in the magnifying observation device 10.

As illustrated in FIG. 11, the magnifying observation device 10 further includes the plurality of base legs 120. The plurality of base legs 120 are provided on a lower surface of the base 1. The plurality of base legs 120 include seating legs 121 and short legs 122. The seating legs 121 are seated on a vibration isolator VR (or another horizontal plane) on which the magnifying observation device 10 is installed. The short legs 122 are shorter than the seating legs 121 in the up-down direction, and thus, are not seated on the vibration isolator VR (or another horizontal plane). A difference d in the length in the up-down direction between the seating leg 121 and the short leg 122 is larger than a tolerance in the up-down direction of the base leg 120, and is about 0.05 mm to 0.15 mm (for example, 0.10 mm). The vibration isolator VR may be an active vibration isolator or a passive vibration isolator.

As illustrated in FIG. 12, centroids C1 of the seating legs 121 are located at apexes of a protruding polygon P in the bottom view. Centroids C2 of the short legs 122 are located on or inside lines of protruding polygon P other than the apexes of the protruding polygon P. FIG. 12 illustrates an example in which the protruding polygon P is a quadrangle P. In the example of FIG. 12, the centroids C1 of the seating legs 121 are located at apexes of the quadrangle P, and the centroids C2 of the short legs 122 are located on a line of the quadrangle P. FIG. 13 illustrates an example in which the protruding polygon P is a hexagon P. In the example of FIG. 13, the centroids C1 of the seating legs 121 are located at apexes of the hexagon P, and the centroids C2 of the short legs 122 are located inside the hexagon P. The protruding polygon P is not limited to the quadrangle P (FIG. 12) or the hexagon P (FIG. 13), and may be a triangle or a pentagon, or may be a heptagon or more.

Only the seating leg 121 in which the centroid C1 is located at the apex of the protruding polygon P is seated on the vibration isolator VR (or another horizontal plane). Therefore, the magnifying observation device 10 does not rattle on the vibration isolator VR (or another horizontal plane). As a result, the magnifying observation device 10 can improve the resistance to vibration.

In a case of being installed on a place other than the vibration isolator VR (another horizontal plane or the like), the magnifying observation device 10 may further include vibration isolation legs (not illustrated) to be put on the plurality of base legs 120, respectively. The vibration isolation leg is made of an elastic material (a gel-like material or the like).

All of the plurality of base legs 120 putting on the vibration isolation legs are seated by the elasticity of the vibration isolation legs. Therefore, the magnifying observation device 10 can improve the resistance to vibration by the vibration isolation legs that cause all the base legs 120 to be seated.

Meanwhile, the above embodiments are illustrative in all respects and are not restrictive. The scope of the invention is indicated not by the above description but by the claims, and is intended to include meanings equivalent to the claims and all modifications within the scope. Among the configurations described in the above embodiments, configurations other than the configurations described as one aspect of the invention in “Means for Solving Problems” are arbitrary, and can be appropriately deleted and changed.

The invention provides a magnifying observation device, and has industrial applicability.

What is claimed is:

1. A magnifying observation device for magnifying and observing an object, the magnifying observation device comprising:
a base;
a placement table provided on the base and having a horizontal upper surface for an object to be observed;
a support column extending in a vertical direction from the base;
a movable stage including a rail and a holder movable along the rail, the rail being supported with respect to the support column to be rotatable about a first rotation axis parallel to a first direction along the horizontal upper surface such that the first rotation axis across the movable stage;
an observation head including a camera, the observation head being held by the holder with an optical axis of the camera along a moving direction of the holder of the movable stage, the camera capturing an image of the object via an objective lens to generate the image of the object;
a block detachably attached to the horizontal upper surface of the placement table, and configured to locate a surface for an object to be observed closer to the observation head along the vertical direction; and
an image generation unit configured to generate an observation image based on the image from the camera of the observation head,
wherein a position of the block attached to the horizontal upper surface is changeable in a second direction along the horizontal upper surface by moving the placement table, the second direction are orthogonal to the first direction, and
an angular position of the rail of the movable stage is adjustable with respect to the support column, one of the angular positions to be adjusted includes an angular position such that the moving direction of the holder of the movable stage is orthogonal to the horizontal upper surface.

2. The magnifying observation device according to claim 1, further comprising a rotating holder provided on the support column to be rotatable about the first rotation axis,
wherein the rotating holder holds the movable stage.

3. The magnifying observation device according to claim 2, further comprising a lock mechanism capable of fixing rotation of the rotating holder with respect to the support column.

4. The magnifying observation device according to claim 2, further comprising:
a regulating member disposed on the support column;
a abutting member disposed on the rotating holder, and configured to abut on the regulating member at the angular position where the moving direction of the holder with respect to the rail of the movable stage is orthogonal to the horizontal upper surface;
a tilt angle measurement unit configured to measure a tilt angle representing an angle formed by the moving direction of the holder with respect to the rail of the movable stage and a direction orthogonal to the horizontal upper surface;
a tilt angle display unit configured to display the tilt angle; and
a display angle correction unit controlling the tilt angle display unit to display zero degree of the tilt angle when an abutting member abuts on a regulating member.

5. The magnifying observation device according to claim 2, wherein
the rotating holder includes a rod-like handle, and
a central axis of the rod-like handle is directed toward the first rotation axis and is along a plane orthogonal to the first rotation axis.

6. The magnifying observation device according to claim 1, wherein
the horizontal upper surface of the placement table has a plurality of positioning holes along the second direction, and
the block has a positioning pin insertable into the positioning hole.

7. The magnifying observation device according to claim 6, wherein
the placement table further includes a fixing screw hole,
the block further includes a fixing screw to fix the fixing screw hole, and
the fixing screw corresponds to a position of the fixing screw hole when the positioning pin is inserted into the positioning hole.

8. The magnifying observation device according to claim 6, further comprising a rotating plate rotatably placed on the block about a second rotation axis orthogonal to the horizontal upper surface,
wherein the rotating plate including a surface for an object to be observed.

9. The magnifying observation device according to claim 8, wherein the rotating plate includes a reflector at least on a surface on which the object is placed, the reflector reflecting light to the observation head.

10. The magnifying observation device according to claim 8, wherein
the block has a rotation axis hole at a position of the second rotation axis, and
the rotating plate further includes a rotation axis pin insertable into the rotation axis hole.

11. The magnifying observation device according to claim 10, wherein the block further includes a guide portion guiding the rotation axis pin of the rotating plate to the rotation axis hole.

12. The magnifying observation device according to claim 10, wherein the rotation axis pin of the rotating plate is also insertable into the positioning hole of the placement table.

13. The magnifying observation device according to claim 10, wherein
one of more blocks are stacked on the block, and
the positioning pin of an upper block among the one or more blocks is inserted into the rotation axis hole of a lower block among the block and the one or more blocks.
